(19) United States
(12) Patent Application Publication
(10) Pub. No.: US 2008/0040458 A1
(43) Pub. Date: Feb. 14, 2008

(54) Network file system using a subsocket partitioned operating system platform

(76) Inventors: Vincent J. Zimmer, Federal Way, WA (US); Michael A. Rothman, Puyallup, WA (US)

Correspondence Address: COURTNEY STANFORD & GREGORY LLP;C/O INTELLEVATE, P.O. BOX 52050, MINNEAPOLIS, MN, 55402, US

(21) Appl. No.: 11/503,744

(22) Filed: Aug. 14, 2006

(51) Int. Cl. G06F 15/177

(52) U.S. Cl. 709/220; 709/222

(57) ABSTRACT

Embodiments of a system and method for allowing a network file system to be transparently reflected across a network are described. A platform that has hardware partitioning and sequestering of a set of cores launches a platform with two regions, a general partition (GP) and a sequestered or embedded partition (EP). The general partition runs a general purpose operating system (OS). The embedded partition runs a sequestered runtime, such as an embedded OS or a real-time OS. The general partition and embedded partition communicate through an Inter-Partition Bridge (IPB), which can be a shared memory buffer between the EP and GP or some type of hardware interconnection. The general purpose operating system in the general partition has a file system filter driver that reflects the file system accesses and passes the access to the embedded partition through the IPB. The embedded partition contains a network management stack that can support a series of network file systems, present known network file systems, or proprietary network file sharing mechanisms. Other embodiments are described and claimed.

### FIELD OF THE INVENTION

Embodiments are in the field of computer system platforms, and particularly in the field of network file systems.

### BACKGROUND OF THE DISCLOSURE

The advent of large-scale computer networks has led to expansion of operating systems beyond single-host versions intended to run on a single computer. Network implementations of software allow server and client computers to share data and resources, as well as processing tasks in over the network in an increasingly seamless manner. A key consideration in the implementation of network applications is the storage and maintenance of the files and directories used by the networked computers. These files can be stored on the dedicated or distributed servers on the network, but should be accessible to all other computers as transparently as possible. Network file systems have been developed to allow a client computer to mount partitions of the server computer as if they were physically connected to the client, thus allowing transparent remote access to files over the network. The network file system thus allows the sharing of files, creation of new files, locking of files, and other ownership management tasks by the client computer over the network. Various different types of network file system protocols have been developed, such as the Network Filesystem (NFS) which is available on almost all versions of UNIX as well as a wide variety of other personal computer and workstation level operating systems. Another such system is the Common Internet File System (CIFS) protocol that has been introduced to support rich, collaborative applications over the Internet. CIFS defines a standard remote file system access protocol for use over the Internet, enabling groups of users to work together and share documents across the Internet or over intranets. CIFS is an open, cross-platform technology based on the native file sharing protocols built into most general purpose operating systems, such as Microsoft® Windows™. Still another popular network file system is iSCSI (Internet Small Computer System Interface), which is an Internet Protocol (IP)-based storage networking standard for linking data storage facilities.

With regard to implementation within computers themselves, network functionality can be built into network adapters, but these are typically low in processing power. Another way is to incorporate the network functionality into the operating system itself. Present operating systems, such as Microsoft® XP typically incorporate networkability functions to enable interaction in a network. As network technology advances, protocols governing data transfer and storage are continually updated and developed, and this can present an issue related to the general lack of synchronization between the release of operating systems and network storage protocols. For example, since the release of Microsoft XP in 2001, several network protocols have evolved, which are not supported by the operating system. Moreover, many network protocols, such as CIFS, are only bundled into server operating systems. A further disadvantage of present network file systems is that there is generally no easy way to update a computer platform's networking capability without an operating system or operating system driver update. This can impose a high processing and/or maintenance cost associated with adapting or upgrading general purpose operating systems with new features available from evolving network file system protocols.

### BRIEF DESCRIPTION OF THE DRAWINGS

FIG. 1 is a block diagram of elements of a computer network that includes one or more computers executing a subsocket partitioned network file system, according to an embodiment.

FIG. 2 is a block diagram of elements of a computer system including a subsocket partitioned network file system, according to an embodiment.

FIG. 3 is a diagram illustrating the incorporation of a network management stack in an embedded partition, according to an embodiment.

FIG. 4 is a flow diagram of a method of implementing a subsocket partitioned network file system, according to an embodiment;

### DETAILED DESCRIPTION

Embodiments described herein provide a means by which a network file system can be transparently reflected across a network. A platform that has hardware partitioning and sequestering of a set of cores launches a platform with two regions, a general partition (GP) and a sequestered or embedded partition (EP). The boot firmware uses some platform hardware, such as CSI (Common System Interconnect), Hypertransport (HT), and/or memory isolation capabilities. The general partition runs a general purpose operating system, such as Microsoft Windows or a Linux distribution. The embedded partition runs a sequestered runtime, such as ThreadX X® or Embedded Linux. The general partition and embedded partition communicate through an Inter-Partition Bridge (IPB). The IPB can be a shared memory buffer between the EP and GP or some type of hardware interconnection. The general purpose operating system in the general partition has a file system filter driver that reflects the file system accesses, such as a Windows I/O Request Packet (IRP) and passes the access to the embedded partition through the IPB. The embedded partition can support a series of network file systems, such as NFS, CIFS, and other similar network file systems, or proprietary network file sharing mechanisms.

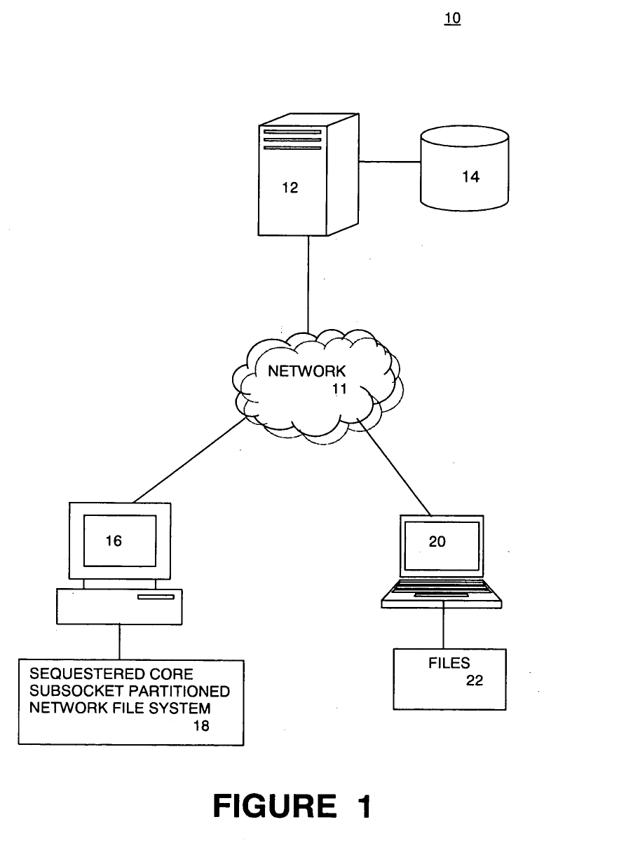

Aspects of the one or more embodiments described herein may be implemented on one or more computers executing software instructions. The computers may be networked in a client-server arrangement or similar distributed computer network. FIG. 1 illustrates a computer network system 10 that implements one or more embodiments. In system 100, a server computer 12 is coupled, directly or indirectly, to one or more network client computers or computing devices 16 and 20 through a network 11. The network interface between the server computer and the client computers may include one or more routers that serve to buffer and route the data transmitted between the server and client computers, and network 11 may be the Internet, a Wide Area Network (WAN), a Local Area Network (LAN), or any combination thereof. As shown in FIG. 1, the client computing devices include a workstation computer 16, a portable computer 20, but are not so limited. The client computing devices can be any class of client computer, such as a personal computer, workstation, server computer, or embedded computing device; or they can be a mobile computing or communication device, such as a notebook computer, personal digital assistant (PDA), mobile phone, game console, or any similar class of mobile computing device with sufficient processing and communication capability.

In one embodiment, network system 10 implements a network file system that allows the computers to share files and programs with one another. Server 12 represents a file server computer that maintains a data store 14 that contains files, data objects, application programs, or any other network resources that can be accessed by the other computers in the network. Mobile computer 20, which contains files 22, represents another type of network accessible computer on the network. One or more of the computers, such as client computer 16 executes a network file system program 18 that allows transparent access to files on the file server 12, or any other suitably configured remote machine, such as mobile computer 20.

The network file system allows the client computer to mount partitions of the server computer as if they were physically connected to the client, thus allowing transparent remote access to files over the network. The network file system thus allows the sharing of files, creation of new files, locking of files, and other ownership management tasks by the client computer over the network. As network storage protocols advance, the general purpose operating systems typically fall out of sync with regard to supporting the latest file sharing capabilities. In one embodiment, the network file system 18 is implemented on a computing platform that is divided into two distinct regions, a general partition (GP) and a sequestered or embedded partition (EP). The general partition is configured to hold the general purpose operating system, while a plurality of network file system capabilities are implemented in the embedded partition. This effectively provides a mechanism whereby the network file system functionality is presented as virtual hardware to the general purpose operating system. The embedded partition is configured to support various types of network file system protocols, such as NFS, CIFS, ISCSI, NTLM (Windows NT LAN Manager), among others.

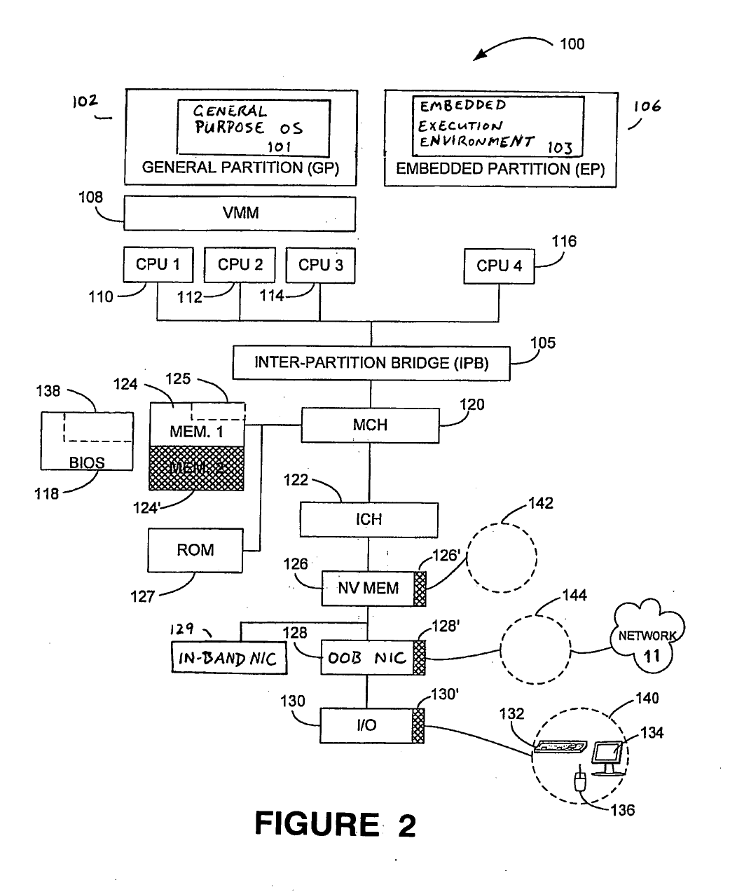

FIG. 2 is a block diagram of elements of a computer system including a subsocket partitioned network file system, according to an embodiment. In one embodiment, computer 100 is a multi-core system that integrates two or more processor logic cores into a single physical processor (socket) of a central processing unit (CPU). For example a “Fat” core system may integrate eight processor cores per socket, and a “Thin” core system may integrate up to 32 cores per socket. The processing space is partitioned into two or more partitions, each with an integral number of processing cores. For the embodiment illustrated in FIG. 2, the processing space is divided into a general partition 102 and an embedded partition 106.

In general, computer 100 has a particular set of hardware that, when working together, allows the computer to execute an operating system (OS), such as Windows, Linux, and so on. Upon successful initiation of an operating system, the computer may thereafter execute particular user applications, such as word processing applications, spreadsheet applications, Internet browser applications, games, policy enforcement applications/procedures, and/or other custom and/or commercial applications.

Prior to executing the applications, the operating system typically initializes and takes control of the computer system hardware, including hard drive(s), memory, input/output (I/O) facilities including, but not limited to disk adapters, compact disk (CD) drives, digital versatile disk (DVD) drives, local area network (LAN) adapters, serial ports, terminals, graphics/audio cards, and so on. The operating system is itself a software application read from a hard drive, thus a base level initialization of the underlying hardware is accomplished via basic input/output system (BIOS) procedures before the operating system may take overall control of the computer. Base level initialization may include initialization of computer components such as, for example, main memory (e.g., random access memory (RAM)), FLASH memory, a non-volatile storage (e.g., a hard drive), CPUs, and/or various chipsets. BIOS initialization of the platform typically results in an OS having full awareness of hardware and software resources available to it.

The computing platform illustrated in FIG. 2 employs platform partitioning, in which one or more processor cores comprise a partition that executes its own OS and/or application. The OS is generally unaware that it is sharing various resources, such as CPU resources, memory, hard disk space, and/or input/output (I/O) devices. Support for each partition may be facilitated by a virtual machine monitor (VMM), which is software that operates between underlying platform hardware and the processor cores. For each instance of a VM, which may be running an OS and/or various executable applications, the VMM manages underlying hardware resources that include, but are not limited to, CPU access time (e.g., time slicing), hard disk space, and memory space to provide execution resources for each VM. The VMM is typically proprietary software that is designed, managed, and updated by third parties, thus CPU hardware manufacturers and/or any users of platforms that employ multiple partitions via the VMM have little or no control over potential security vulnerabilities that exist in the VMM. Although certain applications can be implemented through the use of a VMM, the VMM is typically proprietary software that is designed, managed, and updated by third parties, thus CPU hardware manufacturers and/or any users of platforms that employ multiple partitions through the VMM have little or no control over potential security vulnerabilities that exist in the VMM. Although components of a network file system can be implemented using the VMM, it is advantageous to instead implement these functions as part of an embedded partition running directly on one or more of the processor cores.

The embodiment illustrated in FIG. 2 is a diagram of an example computer platform 100 that implements network file system functionality in an embedded partition, this is essentially a sequestered element and/or process of the platform 100 that is transparent and/or undetected by a general purpose operating system 101 running on the general partition 102. The embedded partitions includes an embedded execution environment 103, that comprise sequestered element(s) and/or process(es) that typically operate under the control of an independent process and/or hardware. In the example platform 100, general partition (GP) 102, may execute a general purpose OS (e.g., Microsoft Windows, a Linux distribution, etc.). The GP 102 is operatively connected by an inter-partition bridge (IPB) 104 to an embedded partition (EP) 106, which is a sequestered executable running on a sequestered processor. The IPB 104 may be a shared memory buffer between the GP 102 and the EP 106, or it may be a hardware interconnection. The IPB 104 may generate an interrupt to the EP 106 to process I/O requests generated by the general purpose OS executing on the GP 102. The GP 102 will typically employ various console filter drivers (e.g., for video display, keyboard, mouse, etc.), such as Windows I/O Request Packets (IRPs). In response to the interrupt generated by the IPB 105, the EP 106 may be capable of determining I/O activity, including, but not limited to, hard drive file access attempts, file edit attempts, file deletion attempts, e-mail transmission attempts, and/or identification of web site addresses matching policy criteria.

The example platform 100 may also include a VMM 108 to support creation and management of VMs (some of which may host the GP) that may use one or more CPUs 110, 112, and 114. A fourth CPU 116 may be sequestered by a BIOS 118 to service the EP 106. The example platform 100 can be implemented by one or more general purpose microprocessors, microcontrollers, a server, a personal computer, a personal digital assistant (PDA), or any other type of computing device.

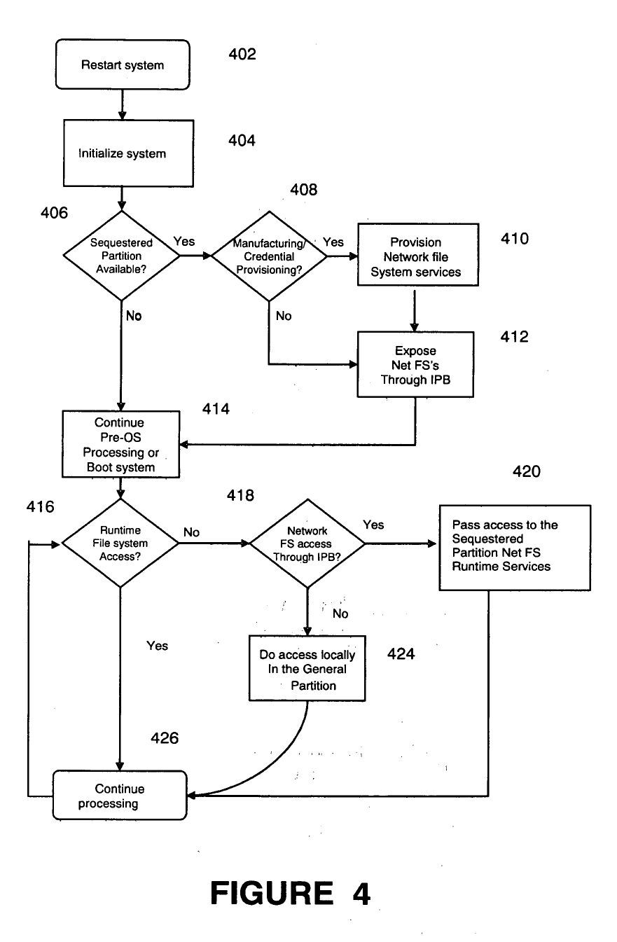

The example platform 100 of the embodiment of FIG. 1 includes four CPUs 110, 112, 114, and 116, each of which may execute coded instructions 125 present in, for example, an external RAM 124 and/or a memory of the processor(s). The processors may be any type of processing unit. The processors may execute, among other things, the example machine accessible instructions of FIG. 4, described in further detail below, to implement a network file system.

All CPUs 110, 112, 114, and 116 are operatively connected to a memory controller hub (MCH) 120 and an I/O controller hub (ICH) 122. The MCH 120 provides an interface for the CPUs and memory 124, balances system resources, and enables concurrent processing for either single or multiple CPU configurations. The ICH 122 forms a direct connection from hard disk drive(s) 126, out-of-bound and in-bound network interface cards (NICs) 128 and 129, and/or various I/O devices 130 (e.g., universal serial bus (USB) ports, serial ports, keyboard 132, mouse 134, and/or video 136) to the main memory 124.

The hard disk drive(s) embodying non-volatile memory 126 may be any type of mass storage device, including floppy disk drives, hard drive disks, compact disk drives, and digital versatile disk (DVD) drives. The NICs 128 and 129 may be any type of communication device, including a modem, to facilitate exchange of data with external computers via the network 11 (e.g., an Ethernet connection, a digital subscriber line (DSL), a telephone line, coaxial cable, a cellular telephone system, etc.).

The processors 110, 112, 114, and 116 are in communication with the main memory (including a read only memory (ROM) 127) via a bus 129 interconnecting platform elements. The RAM 124 may be implemented by dynamic random access memory (DRAM), Synchronous DRAM (SDRAM), and/or any other type of RAM device, and ROM may be implemented by FLASH memory and/or any other desired type of memory device.

The BIOS 118 includes sequestering code 138 to sequester various platform 100 resources before the GP 102, and any corresponding VMs and/or OSs begin to take operational control over the various platform 100 hardware resources. For example, the sequestering code 138 may be stored on a non-volatile memory 126, such as FLASH memory, read only memory (ROM), and/or complementary metal oxide semiconductors (CMOS). The sequestering code 138 may include instructions to initialize various platform hardware systems and/or components in a particular order. For example, during computer power-up, the CPU(s) may execute the sequestering code in a pre-boot, or pre-OS, environment to sequester CPU 4 (116) by initializing chipset(s) and/or other motherboard components associated with CPU 4 (116) while leaving CPUs 1, 2, and 3 (110, 112, 114) in a non-powered state. Although CPU 4 (116) is ready to execute after a reset, it has no instructions at very early stages of the 1310s boot procedures. As such, the CPU typically begins execution at a memory location/address hard-coded by the CPU or chipset. Such memory locations may be chipset and/or CPU dependent or compatible with industry standard locations. By way of illustration, and not limitation, a hard-coded memory location/vector may be near the end of non-volatile memory 126 and then “jump” to an alternate memory location for further instructions. For example, after CPU 4 (116) begins execution, the jump instruction in the non-volatile memory 126 may point to additional boot instructions, including the sequestering code 138.

Additional BIOS instructions, executed pursuant to the sequestering code 138, may cause CPU 4 (116) to run the EP 106 as a sequestered runtime embedded execution environment 103, such as ThreadX® or Embedded Linux. Persons of ordinary skill in the art will appreciate that ThreadX® is a real-time operating system (RTOS) well-suited for embedded applications. RTOSs are typically focused to perform a specific suite of functions, thereby include a relatively small footprint (i.e., they do not occupy much memory or use many processing resources) and operate much faster as compared to commercial general purpose operating systems. The sequestering code 138 may direct the sequestered CPU 4 (116) and EP 106 to further sequester additional components of the platform 100 and/or portions thereof. For example, the EP 106 may sequester a portion of the memory 124′, a portion of the non-volatile memory 126′, a portion of the in band or out-of-band NIC 128′, and/or a portion of the I/O 130′. For ease of illustration, the sequestered portions of the platform 100 are shown as crosshatched in FIG. 1. In general, sequestered platform 100 components and/or portions of such sequestered components are neither available to the general partition 102, nor detected by the general partition 102.

The sequestering code 138 may direct the BIOS 118 to initiate boot instructions for the balance of the platform 100 upon completion of EP 106 initialization and/or component sequestering. BIOS instructions may include, but are not limited to, performing power-on self test (POST) procedures on the memory 124, the non-volatile memory 126 (e.g., hard drive(s)), the NIC 128, and/or various I/O 130, such as a keyboard 132 test, a mouse 134 test, and/or video 136 output test(s).

Generally speaking, upon completion of BIOS boot procedures, both the GP 102 and the EP 106 are independently executing. However, the GP 102 is unaware of the EP 106 and cannot access resources allocated to the EP 106. Furthermore, the GP 102 is unaware of any components that have been sequestered in whole or in part, such as the sequestered memory 124′, the sequestered non-volatile memory 126′ (e.g., several megabytes of hard disk space), the NIC 128′, and/or the I/O 130′.

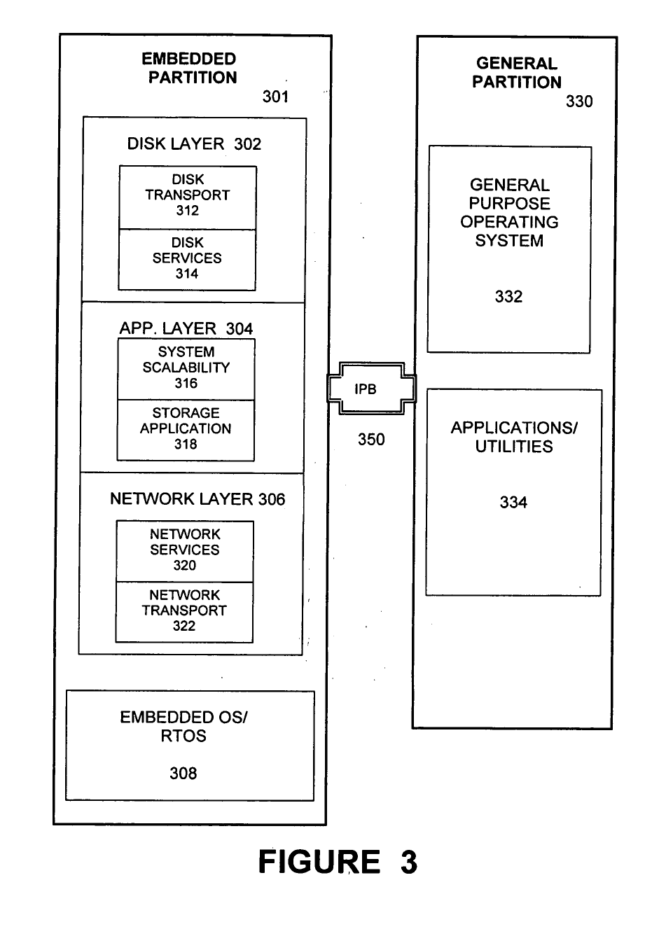

FIG. 3 is a block diagram illustrating the incorporation of a network management stack in an embedded partition, according to an embodiment. FIG. 3 is a partial block diagram of an example of a computer hardware configuration in which embodiments of the invention may be practiced. The system 300 may represent a portion of the computer 100 illustrated in FIG. 2, and may be embodied on one or more motherboards, or integrated circuit devices comprising at least some of the components of the computer. As shown in FIG. 3, the main elements of a network stack including a data storage processing structure are stored in embedded partition 301. These elements comprise a disk layer 302 including disk transport 312 and disk services 314 components; an application layer 304 including system scalability 316 and storage application 318 components; and a network layer 306 including network services 320 and network transport 322 components. The network stack thus includes general functions related to data transport and storage on various layers of the protocol. It should be noted that the embodiment illustrated in FIG. 3, illustrates one of many possible configurations and components of a network management structure, and other structures are possible depending upon the system requirements and constraints. The embedded partition 301 also includes an embedded OS or real-time operating system (RTOS) 308 (such as ThreadX® or Embedded Linux).

Once the network management stack is incorporated in the embedded partition 106, it can be used by the general purpose OS 332 residing in the general partition 330. The GP 330 can also hold various other application programs and utilities 334. For the embodiment shown in FIG. 3, the EP 301 and GP 330 are coupled to one another through an IPB interface 350.

The embodiment illustrated in FIG. 3 shows the network stack effectively implemented or “hidden” in the embedded partition of the system. In one embodiment, the network stack is mapped to the EP by defining a general set of file functions or adapting socket API services, such as open/close, read/write, connect/disconnect, and other similar functions. The embedded partition mechanism and the IPB interconnect effectively present the network management stack to the general purpose OS as a hardware-like resource, rather than a software process or hardware emulation. The network file system platform functions can be delivered with the sequestered core, and as far as the OS in the general partition, this functionality appears to be implemented in hardware, rather than software. The network stack comprising blocks 302, 304, and 306 perform all of the appropriate wire protocol functions of the network file system (e.g., CIFS, NTLM, and so on). These can include TCP/IP (Transmission Control Protocol/Internet Protocol), or any similar protocol functionality to control data flow, acknowledgements, security/authentication, state management, and similar tasks.

The general purpose operating system 332 and any appropriate applications or utilities 334 perform network functions using the network stack elements in the embedded partition 301. The EP 301 effectively works as a multiplexer to provide the GP 330 with the network functions that it requires. These include general file system management, storage and maintenance functions. The local requests on the GP 330 are passed to the EP 301 over the IPB 350 in a manner that supports the implemented network file system. In one embodiment, the general purpose OS 332 has a file system filter driver that reflects the file system accesses, such as a Windows I/O Request Packet (IRP) and passes the access to the embedded partition through the IPB.

With the embodiment of FIG. 3, as hew network file system protocols and/or utilities are developed these need only be mapped to the EP, rather than implemented as part of the OS 332 or as part of a network interface hardware, such as NIC 128 or 129. This facilitates the scalability of existing general purpose and embedded operating systems within the computer with respect to new network file system protocols.

FIG. 4 is a flow diagram of a method of implementing a subsocket partitioned network file system, according to an embodiment the process generally starts with the restarting of the system, block 402. Upon restart, the system is initialized, block 404. This generally involves setting the processors to a known state, clearing the cache, and so on. In block 406 it is determined whether a sequestered partition is available. If no sequestered partition is available the process continues with pre-OS processing or a boot procedure, block 414. If, in block 406, it is determined that a sequestered partition is available, the network file system(s) can be exposed to the general purpose operating system through the IPB, as shown in block 412. The process first checks whether a manufacturing/credential provisioning mechanism is present, block 408. If so, the network file system services are provisioned (block 410) prior to exposure of the network file systems through the IPB.

After the network file systems are made available, or if no sequestered partition is available, the process proceeds with continued pre-OS processing or a boot procedure, block 414. The availability of runtime file system access is then checked, block 416. If it is, processing continues, as shown in the processing loop with block 424. If runtime file system access is not available, the process checks whether network file system access is available through the IPB, block 418. If network file system access is not available through the IPB, the processor(s) access the network file systems locally in the general partition, block 422, and continue processing. If, in block 418, it is determined that network file system access is available through the IPB, access by the processors is passed to the sequestered partition network file system runtime services, as shown in block 420, and processing then continues, block 424.

The network file system and management functions illustrated in FIG. 3 can be used to facilitate the transport and storage of data across a variety of different transport protocols and storage devices. Data can be transferred for storage I/O using different protocols (e.g., iSCSI) using various application assists, such as actual or virtual pools (e.g., RAID arrays) of data that are sent for storage using different storage services (e.g., mirroring, snapshot, replication, etc.) over a network with different virtual LUNs (Logical Unit Number) for individual disk drives or storage locations. The network file system implemented within the embedded partition allows the general purpose OS to perform network functions in a seamless manner using the embedded execution environment of the embedded partition. Compared to present OS implemented network file systems, this described use of sequestered processors to provide multi-protocol network storage support can generally result in faster wire speeds, and therefore, lower transfer latencies over the network, thus increasing overall system performance.

For the purposes of the present description, the term “processor” or “CPU” refers to any machine that is capable of executing a sequence of instructions and should be taken to include, but not be limited to, general purpose microprocessors, special purpose microprocessors, application specific integrated circuits (ASICs), multi-media controllers, digital signal processors, and micro-controllers, etc.

The memory associated with system 100 may be embodied in a variety of different types of memory devices adapted to store digital information, such as static random access memory (SRAM), dynamic random access memory (DRAM), synchronous dynamic random access memory (SDRAM), and/or double data rate (DDR) SDRAM or DRAM, and also non-volatile memory such as read-only memory (ROM). Moreover, the memory devices may further include other storage devices such as hard disk drives, floppy disk drives, optical disk drives, etc., and appropriate interfaces. The system may include suitable interfaces to interface with I/O devices such as disk drives, monitors, keypads, a modem, a printer, or any other type of suitable I/O devices.

Aspects of the methods and systems described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Implementations may also include microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

While the term “component” is generally used herein, it is understood that “component” includes circuitry, components, modules, and/or any combination of circuitry, components, and/or modules as the terms are known in the art.

The various components and/or functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

The above description of illustrated embodiments is not intended to be exhaustive or limited by the disclosure. While specific embodiments of, and examples for, the systems and methods are described herein for illustrative purposes, various equivalent modifications are possible, as those skilled in the relevant art will recognize. The teachings provided herein may be applied to other systems and methods, and not only for the systems and methods described above. The elements and acts of the various embodiments described above may be combined to provide further embodiments. These and other changes may be made to methods and systems in light of the above detailed description.

In general, in the following claims, the terms used should not be construed to be limited to the specific embodiments disclosed in the specification and the claims, but should be construed to include all systems and methods that operate under the claims. Accordingly, the method and systems are not limited by the disclosure, but instead the scope is to be determined entirely by the claims. While certain aspects are presented below in certain claim forms, the inventors contemplate the various aspects in any number of claim forms. Accordingly, the inventors reserve the right to add additional claims after filing the application to pursue such additional claim forms for other aspects as well.

What is claimed is:

1. A method of implementing a network file system in a computer, comprising:
initializing a first processing unit;
accessing sequestering code with the initialized first processing unit;
initializing a general partition comprising an operating system; and
initializing an embedded partition coupled to the general partition, the embedded partition comprising a sequestered runtime environment containing a network management stack for the network file system.

2. The method of claim 1, further comprising initializing a second processing unit to execute the operating system.

3. The method of claim 2, wherein the embedded partition and the general partition are coupled through an inter-partition bridge.

4. The method of claim 3, wherein the inter-partition bridge comprises one of a buffer memory shared by the embedded partition and the general partition, and a hardware interconnection between the embedded partition and the general partition.

5. The method of claim 3, further comprising coupling the computer to at least one other computer over a network, the network file system controlling transmission and storage functions of data stored on the network.

6. The method of claim 1, further comprising mapping the network file system to the embedded partition through a file system application program interface including at least one utility to process files containing the data stored on the network.

7. The method of claim 6, wherein the at least one utility is selected from the group consisting of opening files, closing files, reading data, writing data, connecting to the network, and disconnecting from the network.

8. The method of claim 1, wherein the network file system in the network management stack in the embedded partition is selected from the group consisting of a disk layer, an application layer, and a network layer.

9. The method of claim 8, wherein:
the disk layer comprises a disk transport component and a disk services component;
the application layer comprises a system scalability component and a storage application component; and
the network layer comprises a network services component and a network transport component.

10. An apparatus to perform network file system functions in a computer coupled to a network, the apparatus comprising:
a first processing unit to execute network file system processes in an embedded partition to facilitate network data transfers over the network; and
a second processing unit to execute a general purpose operating system in a general partition, the general purpose operating system to process data transferred over the network.

11. The apparatus of claim 10 wherein the embedded partition comprises a first subsocket of a central processing unit, and the general partition comprises a second subsocket of the central processing unit.

12. The apparatus of claim 11, further comprising a sequestered runtime environment executing in the embedded partition.

13. The apparatus of the 12, wherein the sequestered runtime environment comprises one of an embedded process, and a real time operating system.

14. The apparatus of claim 10, further comprising an inter-partition bridge coupling the embedded partition to the general partition.

15. The apparatus of claim 14 wherein the inter-partition bridge is selected from the group consisting of a buffer memory shared between the embedded partition and the general partition, and a hardware interconnection between the embedded partition and the general partition.

16. The apparatus of claim 14, wherein the computer is coupled to at least one other computer over a network, the network file system to control transmission and storage functions of data stored on the network, and wherein the network comprises the Internet and the network file system comprises a Transmission Control Protocol/Internet Protocol transmission system.

17. An article of manufacture storing machine-readable instructions which, when executed, cause the machine to:
initialize a first processing unit;
access sequestering code with the initialized first processing unit;
initialize a general partition comprising an operating system; and
initialize an embedded partition comprising a sequestered runtime environment, and coupled to the general partition, the embedded partition containing a network management stack for the network file system.

18. The article of manufacture of claim 17, wherein the machine readable instructions cause the machine to execute the operating system with a second processing unit.

19. The article of manufacture of claim 18 wherein the computer is coupled to at least one other computer over a network, and the machine readable instructions cause the machine to cause the network file system to control transmission and storage functions of data stored on the network.

20. The article of manufacture of claim 19, wherein the network file system is mapped to the embedded partition through a file system application program interface including at least one utility to process files containing the data stored on the network, and wherein the at least one utility is selected from the group consisting of opening files, closing files, reading data, writing data, connecting to the network, and disconnecting from the network.
